(19) United States
(12) Patent Application Publication
(10) Pub. No.: US 2007/0184261 A1
(43) Pub. Date: Aug. 9, 2007

(54) Assembly comprising two metallic parts protected against the formation of a galvanic couple

(75) Inventor: Andre Donnadieu, Colomiers (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: AIRBUS FRANCE, Toulouse (FR)

(21) Appl. No.: 10/994,285

(22) Filed: Nov. 23, 2004

(30) Foreign Application Priority Data
Nov. 27, 2003 (FR) 03 50920

(51) Int. Cl. B32B 5/16

(52) U.S. Cl. 428/323

(57) ABSTRACT

The invention relates to an assembly (1) comprising a first metallic part (2) and a second metallic part (4) assembled together and made from different materials, the first and second parts being provided with a first contact surface and a second contact surface (2a,4a) respectively in contact with each other, at least one of the contact surfaces being provided with a protective coating (12,14) capable of preventing the metallic parts from forming a galvanic couple. According to the invention, at least one protective coating comprises a coat of paint (12a,14a) containing a filler of particles conducting electricity. To be applied to the domain of fluid conveyance systems onboard an aircraft.

### TECHNICAL FIELD

This invention relates in general to the domain of protection of metallic parts assembled together and in contact with each other, against the formation of a galvanic couple between these metallic parts made from different materials.

For example, the invention may be used in applications in fluid conveyance systems, particularly systems onboard aircraft and for example through which a hydraulic fluid or fuel will pass.

### STATE OF PRIOR ART

Regardless of the technical domain considered, for a wide variety of reasons it is sometimes necessary to assemble metallic parts made from different materials.

For example, when making a fluid conveyance system for an aircraft, some elements such as conveyance tube fittings are made from steel particularly to resist surrounding loads, while other elements such as conveyance tubes are made from an aluminum alloy so that the system will have good heat dissipation and electrical conductivity properties and a relatively low total mass.

However, it is well known that when two metallic parts made from different materials are in contact with each other, a galvanic couple is set up between these two parts that is materialised by the creation of an electrical current generated by the potential difference between the two metallic materials. Thus, when the contact surfaces of these two metallic parts are not protected against formation of the above mentioned galvanic couple, these surfaces in contact with each other are affected by harmful effects such as galvanic corrosion.

Sometimes it is also necessary to obtain good electrical conductivity in the connection located between the two metallic parts in contact. Still considering the illustrative example of the fluid conveyance system for aircraft, this good electrical conductivity is necessary particularly to assure personnel safety, protection of equipment against short circuits, dissipation of electrostatic charges related to fluid conveyance, grounding of currents induced by electromagnetic radiation, etc.

It is known that the bond between these surfaces may have the disadvantage of having lower electrical conductivity characteristics than would be obtained for a monolithic metallic part, depending on the nature of the two metallic materials used to make the contact surfaces of the assembled parts.

In order to face the various constraints mentioned above, according to prior art it has been proposed that a protective coating may be made on one or the other of the contact surfaces of the metallic parts, in order to prevent the two parts from forming a galvanic couple and consequently preventing galvanic corrosion of these contact surfaces.

One known solution to produce this protective coating consists of depositing a cadmium layer by electrochemistry on the contact surface(s) of the metallic parts. Consequently, for example when the assembled parts are made from steel and from aluminum alloy, cadmium protects the steel part against galvanic corrosion while making a connection with good electrical conductivity between the two parts.

However, apart from the fact that cadmium electrochemical deposition technique introduces non-negligible production costs, the main disadvantage of this solution according to prior art is directly due to the fact that cadmium belongs to the heavy metals family.

Various recent regulations (directive 91/338/CEE, protocol signed by the European Community in Aarhus on Jun. 24, 1998, etc.), oblige manufacturers more and more strictly limit the use of heavy metals due to risks of pollution by release into the environment.

Furthermore, depending on the conditions of use of the heavy metal considered, it may introduce serious risks for the health of persons working on installations in which this heavy metal is used.

### OBJECT OF THE INVENTION

Therefore, the purpose of the invention is to propose an assembly comprising two metallic parts assembled together made from different materials, at least one of the contact surfaces of the two parts being provided with a protective coating capable of preventing these metallic parts from forming a galvanic couple, the assembly at least partially overcoming the disadvantages mentioned above related to embodiments according to prior art.

Another purpose of the invention is to present an aircraft provided with such an assembly, and a method for manufacturing this assembly.

To achieve this, the first purpose of the invention is an assembly comprising first and second metallic parts assembled together and made from different materials, the first and second parts being provided with a first contact surface and a second contact surface respectively in contact with each other, at least the first or the second contact surface being provided with a protective coating capable of preventing the first and second metallic parts from jointly forming a galvanic couple. According to the invention, at least one protective coating comprises a coat of paint containing particles conducting electricity.

Advantageously, the presence of at least one coat of paint containing particles conducting electricity between the two contact surfaces of the parts can prevent galvanic coupling between these surfaces, because there is no longer any direct contact between them. Consequently, these contact surfaces are protected against galvanic corrosion.

Furthermore, conventional methods used to deposit a coat of paint, such as simple spraying using a spray gun, are far less complex than methods used for electrochemical deposition of cadmium, which directly reduces production costs for the assembly according to the invention.

Secondly, the coat(s) of paint containing particles conducting electricity advantageously enable electrical conduction between the two metallic parts of the assembly, which assures safety of persons, protection of equipment against short circuits, dissipation of electrostatic charges caused by fluid conveyance, grounding of currents induced by electromagnetic radiation, etc.

Obviously, the composition of coats of paint containing particles conducting electricity is determined such that these coats only form extremely small galvanic couples in association with the contact surfaces of the metallic parts of the assembly with which they are in direct contact. In other words, the composition of coats of paint containing particles conducting electricity is determined such that galvanic couples formed by coats of paint and contact surfaces of the metallic parts are firstly very much smaller than the galvanic couple that could be formed jointly by these same two metallic parts, and secondly small enough so that they do not cause any significant corrosion of the metal parts considered.

To achieve this, as a non-limitative example, it is possible to ensure that coats of paint containing particles conducting electricity have exactly the same composition as coats of paint used for electromagnetic compatibility (EMC), or a similar composition, in order to make electromagnetic shielding, for example in the case of electrical or electronic boxes.

These coating paints used for electromagnetic compatibility usually include a binder (acrylic, epoxy, urethane, etc.) and a metal (nickel, silver, copper, etc.) or graphite conducting filler. In this respect, an acrylic-nickel type of paint is frequently used for electromagnetic compatibility, and is quite suitable for the assembly according to the invention.

Also for guidance, the particles used in each coat of paint containing particles conducting electricity may be carbonaceous and/or metallic.

Preferably, each protective coating provided on the assembly is composed exclusively of one coat of paint containing a filler of particles conducting electricity. Consequently, even if a coat of paint can be obtained by applying various undercoats with identical or different compositions one after the other, it is therefore particularly easy and fast to apply this coat, particularly in comparison with the electrochemical deposition technique.

Another purpose of the invention is an aircraft comprising at least one assembly like that described below. Thus, in this case, the assembly can then form an integral part of a fluid conveyance system, for example for a hydraulic fluid or fuel, or it may form any assembly between two metallic parts of the aircraft made from different materials, such as an assembly composed of a steel fitting mounted on a structure made from aluminum alloy.

Finally, the assembly may comprise more than two metallic parts in contact. In this case, it could be possible for each pair of metallic parts in contact to be protected against the formation of a galvanic couple between the two parts in this couple, in the manner described above by providing at least one coat of paint containing a filler of particles conducting electricity.

Furthermore, the purpose of this invention also relates to a method of manufacturing an assembly comprising a first and a second metallic part assembled together and made from different materials, the first and second parts being provided with a first contact surface and a second contact surface respectively in contact with each other, the method including a step to protect the metallic parts consisting of forming a protective coating on at least the first or the second contact surface, each protective coating being capable of preventing the first and second metallic parts from cooperating to form a galvanic couple. According to the invention, at least one protective coating is formed so as to include a coat of paint containing a filler of particles conducting electricity.

Finally, another purpose of this invention relates to the use of a paint containing a filler of particles conducting electricity to form a protective coating capable of preventing the formation of a galvanic couple between a first and a second metallic part in contact and assembled together, and made from different materials.

Other advantages and characteristics of the invention will become clear after reading the non-limitative detailed description given below.

### BRIEF DESCRIPTION OF THE DRAWINGS

This description will be made with reference to the appended drawings among which;

FIG. 1 shows a diagrammatic sectional view of an assembly according to a first preferred embodiment of this invention; and

FIG. 2 shows a diagrammatic sectional view of an assembly according to a second preferred embodiment of this invention.

### DETAILED DESCRIPTION OF PREFERRED EMBODIMENTS

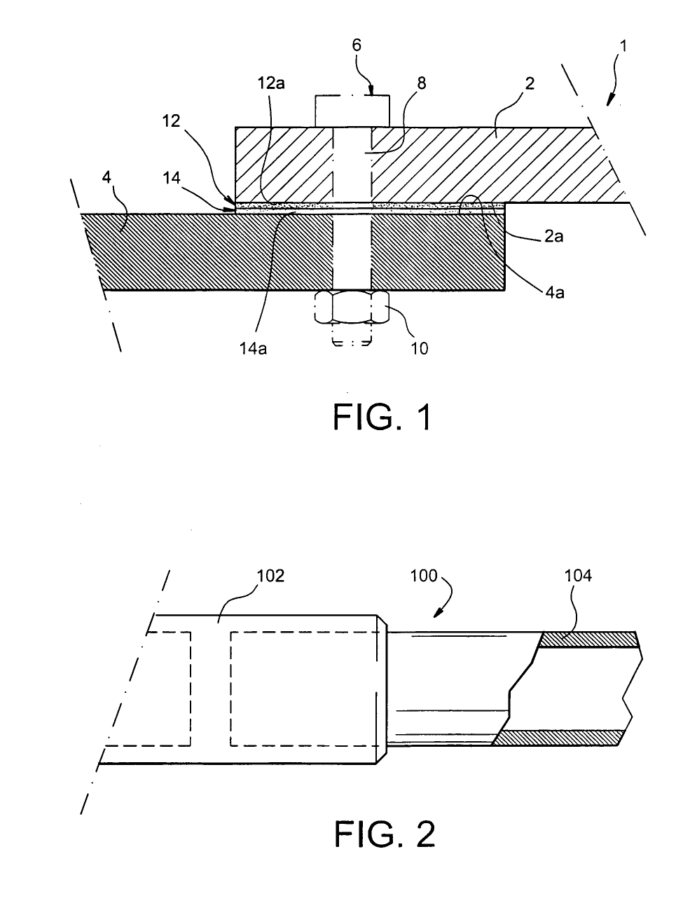

FIG. 1 shows assembly 1, according to a first preferred embodiment of this invention.

The assembly 1 comprises a first metallic part 2 and a second metallic part 4 assembled together using assembly means 6, for example composed of a screw 8 and a nut 10. These parts 2 and 4 are made from different materials such as steels and aluminum alloys, and are preferably in the form of two plates in contact assembled so as to be approximately parallel to each other.

In order to enable the assembly of metallic parts 2 and 4, the first metallic part 2 is provided with a first contact surface 2a bearing on a second contact surface 4a forming part of the second metallic part 4, the surfaces 2a and 4a preferably being plane surfaces.

In this first preferred embodiment of this invention, the two contact surfaces 2a and 4a are each provided with a protective coating 12, 14 capable of preventing the metallic parts 2 and 4 from cooperating to form a galvanic couple, due to the insertion of these two coatings 12 and 14 between the two contact surfaces 2a and 4a. Consequently, as can be clearly seen in FIG. 1, it can be understood that the protective coatings 12 and 14 are in direct contact with each other, rather than the contact surfaces 2a and 4a that support them, although it can be considered that these contact surfaces bear on each other. It should be noted that the coatings 12 and 14 have deliberately been shown with exaggerated thicknesses in FIG. 1, for reasons of clarity.

Still in this first preferred embodiment, each of the two protective coatings 12 and 14 is exclusively composed of a coat of paint 12a and 14a containing particles conducting electricity, for example the particles used may be carbonaceous particles such as graphite or carbon, and/or nickel type metallic particles. For example, the thickness of each coat of paint 12a, 14a does not exceed 150 micrometers.

Although an assembly 1 comprising two parts 2 and 4 is described, in which each part has a coat of paint 12a and 14a containing particles conducting electricity, it is quite obvious that this assembly 1 may comprise only a single coat applied to either one of the contact surfaces 12a and 14a, still with the purpose of preventing the two metallic parts 2 and 4 from forming a galvanic couple.

In this respect, in a first illustrative example, the first part 2 is made from carbon steel, and the second part 4 is made from an aluminum alloy. In this case, only the first contact surface 2a of the part 2 might be coated with a coat of paint containing particles conducting electricity, particularly when the second contact surface 4a of the second part 4 is already actually protected by an electrically conducting coating such as alodine. Furthermore, if the second contact surface 4a is not already protected by an electrically conducting coating, it may be provided with a coat of paint containing particles conducting electricity as shown in FIG. 1.

In the second illustrative example, the first part 2 is made from stainless steel, for which the resistance of its contact surface 2a to galvanic corrosion is sufficient even when it is not protected by a protective coating, and the second part 4 is made from an aluminum alloy. In the case in which the second contact surface 4a of the second part 4 is not already protected by an electrically conducting coating such as alodine, only this second contact surface 4a might be coated with a coat of paint containing particles conducting electricity. Furthermore, when the second contact surface 4a of the second part 4 is already protected by an electrically conducting coating, the single coat of paint provided may be applied to either of the two contact surfaces 12a and 14a, for example depending on the ease of application. Once again, it will still be possible for a protective coating to be applied to the two contact surfaces 12a and 14a, as illustrated in FIG. 1.

In these two illustrative examples, the use of particles such as graphite or carbon particles, and/or nickel type metallic particles, is quite suitable to assure that galvanic couples formed by coats of paint 12a, 14a and contact surfaces 2a, 4a of the metallic parts 2, 4 are firstly very much smaller than the galvanic couple that might be formed jointly by these two metallic parts, and secondly sufficiently small to not cause significant corrosion of the metallic parts considered.

With reference to FIG. 2, the figure shows an assembly 100 according to a second preferred embodiment of this invention, forming an integral part of a fluid conveyance system for an aircraft, for example through which a hydraulic fluid or fuel will pass.

The assembly 100 comprises a first and a second metallic part 102 and 104 assembled together and being made from different materials such as steel and aluminum alloys.

In this second preferred embodiment of this invention, the first part 102 made from steel is a fluid conveyance tube fitting, and the second part 104 made from an aluminum alloy is a fluid conveyance tube. Therefore the two metallic parts 102 and 104 are in contact and are assembled together in a conventional manner.

In the same way as above, the fitting 102 and the tube 104 each have one contact surface (not shown), preferably approximately cylindrical, in which one and/or the other is coated with a protective coating like that described in the first preferred embodiment of this invention. Consequently, the paint coat(s) containing particles conducting electricity provided on the contact surface(s) of parts 102 and 104 will then be approximately cylindrical in shape.

Naturally, without going outside the scope of the invention, the assembly 100 could also be defined as including a larger number of metallic parts in contact forming part of the fluid conveyance system. For example, the assembly 100 could be defined as comprising a complementary fluid conveyance tube connected to the fitting 102 and communicating with the tube 104 described above, the assembly between the fitting 102 and this complementary tube (not shown) then being identical or similar to the assembly between the same fitting 102 and the tube shown in FIG. 2, and described above.

In this respect, it should be noted that the metallic parts in contact and assembled together, in assembly 100, may form tube fittings or fluid conveyance tubes as disclosed above, but may also be in the form of any other component of the fluid conveyance system.

For example, it may apply to the connection of a tube to a heat exchanger, or an assembly of a tube and a tube support onto the aircraft structure, or any other assembly comprising at least one aluminum part in contact with another carbon steel or stainless steel part.

Obviously, those skilled in the art could make various modifications to assemblies 1 and 100 that have been described above, simply as non-limitative examples.

1. Assembly (1, 100) comprising a first metallic part (2, 102) and a second metallic part (4, 104) assembled together and made from different materials, the first and second parts (2, 4, 102, 104) being provided with a first contact surface (2a) and a second contact surface (4a) respectively, in contact with each other, at least one of said first and second contact surfaces (2a, 4a) being provided with a protective coating (12, 14) capable of preventing said first and second metallic parts (2, 4, 102, 104) from forming a galvanic couple, characterised in that at least one protective coating (12, 14) comprises a paint coat (12a, 14a) containing a filler of particles conducting electricity.

2. Assembly (1, 100) according to claim 1, characterised in that each protective coating (12, 14) is composed exclusively of one coat of paint (12a, 14a) containing a filler of particles conducting electricity.

3. Assembly (1, 100) according to claim 1 or claim 2, characterised in that the first metallic part (2, 102) is made from carbon steel and the second metallic part (4, 104) is made from an aluminum alloy, and in that only the first contact surface (2a) is coated with a protective coating.

4. Assembly (1, 100) according to claim 1 or claim 2, characterised in that the first metallic part (2, 102) is made from stainless steel and the second metallic part (4, 104) is made from an aluminum alloy, and in that only the second contact surface (4a) is coated with a protective coating.

5. Assembly (1, 100) according to any one of the previous claims, characterised in that for each coat of paint (12a, 14a) containing a filler of particles conducting electricity, said particles are carbon and/or metal particles.

6. Assembly (100) according to any one of the previous claims, characterised in that said first part (102) is a fluid conveyance tube fitting, and in that said second part (104) is a fluid conveyance tube.

7. Assembly (1, 100) according to any one of the previous claims, characterised in that it comprises more than two metallic parts in contact.

8. Aircraft comprising at least one assembly (1, 100) according to any one of the previous claims.

9. Method for manufacturing an assembly (1, 100) comprising a first metallic part (2, 102) and a second metallic part (4, 104) assembled together and made from different materials, the first and second parts (2, 4, 102, 104) being provided with a first contact surface (2a) and a second contact surface (4a) bearing on each other, said method comprising a step to protect said metallic parts (2, 4, 102, 104) consisting of forming a protective coating (12, 14) on at least the first or the second contact surface (2a, 4a), each protective coating (12, 14) being capable of preventing the first and second metallic parts (2, 4, 102, 104) from cooperating to form a galvanic couple, characterised in that at least one protective coating (12, 14) is formed so as to include a coat of paint (12a, 14a) containing a filler of particles conducting electricity.

10. Use of a paint containing a filler of particles conducting electricity to form a protective coating (12, 14) capable of preventing a first metallic part (2, 102) and a second metallic part (4, 104) from forming a galvanic couple, these parts being in contact and assembled together, and being made from different materials.
